(19) United States
(12) Patent Application Publication
(10) Pub. No.: US 2009/0042063 A1
(43) Pub. Date: Feb. 12, 2009

(54) MAGNETIC RECORDING MEDIUM

(75) Inventors: Tetsutaro INOUE, Osaka (JP); Kazutaka Matsuo, Osaka (JP); Takayuki Owaki, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 12/167,072

(22) Filed: Jul. 2, 2008

(30) Foreign Application Priority Data
Jul. 3, 2007 (JP) P2007-175231

(51) Int. Cl. G11B 5/667

(52) U.S. Cl. 428/829

(57) ABSTRACT

A magnetic recording medium comprising a nonmagnetic substrate, and a soft magnetic layer and a ferromagnetic layer formed in this order on the nonmagnetic layer, in which the ferromagnetic layer has a thickness of from 3 to 150 nm, contains spherical, ellipsoidal or plate-form ferromagnetic particles and a binder, and has an axis of easy magnetization substantially in the vertical direction, and the soft magnetic layer contains spherical or ellipsoidal Fe—Co-containing soft magnetic particles having a saturation magnetization of from 170 to 220 Am²/kg, and a binder.

### FIELD OF THE INVENTION

The present invention relates to magnetic recording media excellent in high density recording characteristics.

### PRIOR ART

Coating type magnetic recording media which comprise a magnetic layer containing a magnetic powder dispersed in a binder are required to be further improved in recording density characteristics, since recording-reproducing systems progress from analog systems to digital systems. This requirement has been growing year after year, especially in the field of magnetic recording media for use in high density digital video tapes, computer backup tapes, etc.

To improve the recording density characteristics of such recording media, the particle size of magnetic powder is made smaller and smaller in these years so as to correspond to the trend of recording with shorter wavelengths. Presently, magnetic powders comprising acicular iron-based metal magnetic particles with a longer axis of about 0.1 μm are practically used. In addition, to prevent output decrease due to demagnetization during recording with short wavelengths, magnetic powders having a larger coercive force have been developed in these years. For example, a magnetic powder which comprises iron-based metal magnetic particles and has a coercive force of about 199.0 kA/m has been realized by iron-cobalt alloying (JP-A-03-49026). However, in the case of a magnetic recording medium comprising these acicular magnetic particles, the coercive force thereof depends on the shape of the magnetic particles. Therefore, in the state of art, the development of very fine particles having a largely decreased major axis is difficult.

When the wavelengths of signals to be recorded are decreased for the purpose of high density recording, there arise not only a problem that an output from a recording medium becomes several times lower relative to such signals within the short wavelength range, because of the levels of the saturation magnetization and coercive force of the conventional magnetic powder, but also a problem that the influences of a self-demagnetization loss during the recording/reproducing of signals and a thickness loss attributed to the thickness of a magnetic layer become more serious, which leads to insufficient resolution. For these reasons, a magnetic recording medium with a multi-layer structure comprising a nonmagnetic layer as a lower layer and a magnetic layer with a thickness of about 0.2 μm as an upper layer are practically used for a computer backup tape such as LTO (Linear Tape Open) and DLT (Digital Linear-Tape), in order to reduce the thickness of the magnetic layer.

In the above-described magnetic recording media, the magnetic particles are oriented in the length-wise direction of the media. On the other hand, there are proposed some magnetic recording media comprising a magnetic layer containing magnetic particles oriented in a vertical direction to have an axis of easy magnetization in the vertical direction so that the vertical component of the residual magnetization of the magnetic layer becomes larger than the in-plane component, in order to improve the reproducing output (JP-A-57-183626, JP-A-59-167854 and JP-A-2-254621). The magnetic recording medium of this type in which the magnetic particles are oriented in the vertical direction has an advantage, i.e., a higher output, because of a small demagnetizing field around a magnetization transition region which is a boundary for a recording bit, and because of a lower self-demagnetization. However, the conventional acicular magnetic particles are easily oriented in the lengthwise direction by the mechanical orientation during coating, and thus, it is difficult to orient such magnetic particles in the vertical direction, and the surface smoothness of the resultant magnetic layer tends to degrade since the magnetic particles project from the surface of the magnetic layer due to the vertical orientation thereof. Therefore, it is essentially unsuitable to orient acicular magnetic particles in the vertical direction in a thickness range of the magnetic layer in which the major axial length of the acicular magnetic particles is of the same level as the thickness of the magnetic layer. Therefore, no coating type magnetic recording medium that comprises a magnetic layer containing magnetic particles oriented in the vertical direction has been commercialized so far.

Under such a situation, a magnetic recording medium was proposed, which comprises a low coercive force layer containing magnetic particles with a low coercive force, and a thin upper magnetic layer containing particulate iron nitride-based magnetic particles oriented in a vertical direction, formed on the low coercive force layer (JP-A-2004-335019). According to this magnetic recording medium, the upper magnetic layer has a superior surface smoothness, even if the thickness thereof is thin, since the upper magnetic layer contains the particulate iron nitride-based magnetic particles having a high coercive force and a high saturation magnetization. Therefore, this magnetic recording medium can show a high reproducing output.

In the computer backup system such as LTO or the like, the shortest recording wavelength of about 0.15 μm is used. For the improvement of the recording density of a recording medium, it is necessary to use a far smaller shortest recording wavelength (for example, 0.1 μm or less). To this end, the above-described magnetic recording medium in which particulate magnetic particles are oriented in a vertical direction is also required to be further improved in reproduction output and resolution, by narrowing a magnetization transition width found when a recording current is inverted, and quickly recording such a chance in magnetization.

### SUMMARY OF THE INVENTION

An object of the present invention is to provide a magnetic recording medium which is excellent in reproduction output and resolution even when signals are recorded with very short wavelengths so as to achieve high density recording.

The present invention provides a magnetic recording medium comprising a nonmagnetic substrate, and a soft magnetic layer and a ferromagnetic layer formed in this order on the nonmagnetic layer, wherein

the ferromagnetic layer has a thickness of from 3 to 150 nm, contains spherical, ellipsoidal or plate-form ferromagnetic particles and a binder, and has an axis of easy magnetization substantially in the vertical direction, and

the soft magnetic layer contains spherical or ellipsoidal Fe—Co-containing soft magnetic particles having a saturation magnetization of from 170 to 220 Am²/kg, and a binder.

The present inventors found that good recording/reproducing characteristics with short recording wavelengths are obtained, when spherical or ellipsoidal Fe—Co-containing soft magnetic particles having a high saturation magnetization are used as magnetic particles in the lower soft magnetic layer of a magnetic recording medium which comprises, as an upper layer, a ferromagnetic layer containing spherical, ellipsoidal or plate-form ferromagnetic particles such as iron nitride-based magnetic particles oriented in the vertical direction. As a result of the present inventors' further studies based on such a finding, the use of spherical or ellipsoidal Fe—Co-containing soft magnetic particles having a high saturation magnetization of from 170 to 220 Am²/kg has been found to be effective to remarkably improve a reproduction output and resolution. That is, when a soft magnetic layer densely filled with the spherical or ellipsoidal Fe—Co-containing soft magnetic particles having a high saturation magnetization is provided as a lower layer under the ferromagnetic layer containing the ferromagnetic particles oriented in the vertical direction, an orientation magnetic field easily passes through the layer during a vertical orientation treatment. Further, the lower soft magnetic layer comprising the soft magnetic particles shows little orientation, since the Fe—Co-containing soft magnetic particles have a low coercive force. Consequently, the magnetic influence of the lower soft magnetic layer, which disturbs the orientation of the ferromagnetic particles in the vertical direction, is suppressed, so that the ferromagnetic layer with excellent vertical orientation can be obtained. The provision of the soft magnetic layer as the lower layer can allow the internal magnetization of the soft magnetic layer to enhance the magnetizing strength of the ferromagnetic layer, when signals are recorded on the ferromagnetic layer as the upper layer. Accordingly, the resultant magnetic recording medium can have a narrow-magnetization transition range and show excellent electromagnetic conversion characteristics.

Preferably, the soft magnetic layer has a magnetic permeability of at least 10. When the soft magnetic layer having a high magnetic permeability is formed, the recording sensitivity increases so that the initial rising of the magnetization is made sharp and thus the resolution can be further improved.

The Fe—Co-containing soft magnetic particles preferably comprise aluminum, more preferably 2 to 35 atomic % of aluminum based on the total number of iron and cobalt atoms. When Fe—Co-containing soft magnetic particles comprising aluminum are used, the soft magnetic layer having a high magnetic permeability can be formed.

Preferably, the Fe—Co-containing soft magnetic particles have a particle size of from 2 to 30 nm and an axial ratio of from 1 to 2. In the above-described magnetic recording medium, when the soft magnetic layer as the lower layer comprises very fine spherical or ellipsoidal soft magnetic particles with a low anisotropy, the content of such soft magnetic particles can be increased, and further the degradation of the surface smoothness of the soft magnetic layer attributed to the rotation of the soft magnetic particles during the orientation treatment can be suppressed.

Preferably, the Fe—Co-containing soft magnetic particles have a coercive force of from 2 to 10 kA/m. With the above-described magnetic recording medium, the orientation of the ferromagnetic layer as the upper layer can be further improved because of the formation of the soft magnetic layer having a low coercive force.

Preferably, the soft magnetic layer contains 65 to 90% of the Fe—Co-containing soft magnetic particles. The soft magnetic layer having a high content of the magnetic particles can be formed because of the spherical or ellipsoidal shape of the Fe—Co-containing soft magnetic particles.

Preferably, the ferromagnetic layer has a squareness of from 0.70 to 0.98 in the vertical direction, when the vertical Kerr rotation angle is measured. According to the above-described magnetic recording medium, the rotational motion of the ferromagnetic particles in the ferromagnetic layer as the upper layer is small during the orientation treatment of such particles, since the layer contains the spherical, ellipsoidal or plate-form ferromagnetic particles. The rotational motion of the Fe—Co-containing soft magnetic particles in the lower layer is also small during the orientation treatment of the layer, since the lower layer contains the spherical or ellipsoidal Fe—Co-containing magnetic particles. Since the soft magnetic layer as the lower layer comprises the Fe—Co-containing soft magnetic particles having a high saturation magnetization, an orientation magnetic field easily passes through the lower layer. For this reason, the motion of the ferromagnetic particles due to the rotational motion of the Fe—Co-containing soft magnetic particles at the interface between the ferromagnetic layer and the soft magnetic layer can be reduced, and concurrently, the spherical, ellipsoidal or plate-form ferromagnetic particles in the upper layer can be efficiently oriented. Thus, the ferromagnetic layer can have a high squareness in the vertical direction.

Preferably, the ferromagnetic layer comprises iron nitride-based magnetic particles, Co-based magnetic particles and/or barium ferrite magnetic particles as the ferromagnetic particles. Since these magnetic particles have crystal magnetic anisotropy, the axes of easy-magnetization of the magnetic particles are merely arrayed in the vertical direction during the orientation of the magnetic particles, and the rotational motion of the magnetic particles is small. Therefore, the surface smoothness of the magnetic layer is not degraded, and the magnetic layer can have high surface smoothness suitable for high density recording. These ferromagnetic particles have a high coercive force and a high saturation magnetization and thus they are suitable for high density recording.

Preferably, the ferromagnetic particles have a particle size of from 5 to 50 nm and an axial ratio of from 1 to 2. According to the above-described magnetic recording medium, since the spherical, ellipsoidal or plate-form ferromagnetic particles with a very small particle size and low anisotropy are contained in the ferromagnetic layer as the upper layer, the content of the ferromagnetic particles can be increased, and concurrently, the degradation of the surface smoothness of the ferromagnetic layer attributed to the rotational motion of the ferromagnetic particles during the orientation treatment can be suppressed.

Preferably, the ferromagnetic layer contains the ferromagnetic particles in an amount of 40 to 90%. The spherical, ellipsoidal or plate-form shape of the ferromagnetic particles makes it possible to form the ferromagnetic layer having a high content of the magnetic particles.

A nonmagnetic layer comprising nonmagnetic particles and a binder may additionally be formed between the nonmagnetic substrate and the soft magnetic layer. According to such a magnetic recording medium, the soft magnetic layer with excellent surface smoothness can be formed as the lower layer.

### DETAILED DESCRIPTION OF THE INVENTION

The magnetic recording medium of the present invention contains, in the ferromagnetic layer as an upper layer, spherical, ellipsoidal or plate-form ferromagnetic particles excellent in vertical orientation, and has a soft magnetic layer comprising spherical or ellipsoidal Fe—Co-containing soft magnetic particles having a saturation magnetization of from 170 to 220 Am²/kg which is formed under the ferromagnetic layer in order to improve the output and resolution of the magnetic recording medium. When the soft magnetic layer densely filled with the soft magnetic particles having such a high saturation magnetization is provided under the ferromagnetic layer in which the ferromagnetic particles are oriented in the vertical direction, an orientation magnetic field easily passes through the layer during a vertical orientation treatment, and the internal magnetization of the soft magnetic layer enhances the magnetization intensity of the ferromagnetic layer when signals are recorded on the ferromagnetic layer as the upper layer. Since the Fe—Co-containing soft magnetic particles has a low coercive force, the soft magnetic layer as the lower layer comprising such soft magnetic particles shows little orientation, so chat a decrease in the orientation of the ferromagnetic layer as the upper layer can be suppressed. Thus, the ferromagnetic layer showing excellent vertical orientation can be formed.

In JP-A-2004-335019 cited above, ferrite-based magnetic particles such as Mn—Zn ferrite magnetic particles and Ni—Zn ferrite magnetic particles are used in a soft magnetic layer as a lower layer. However, these ferrite-based magnetic particles are oxide magnetic particles and therefore have a saturation magnetization of at most about 120 Am²/kg, so that an orientation magnetic field hardly passes therethrough in comparison with the Fe—Co-containing soft magnetic particles having a high saturation magnetization. In addition, the ferrite-based magnetic particles have a low effect to enhance the magnetization intensity of the ferromagnetic layer, so that the magnetization transition width tends to increase. Furthermore, the surface smoothness of the ferromagnetic layer tends to degrade, because it is necessary to apply a strong magnetic field to a magnetic paint in order to form a ferromagnetic layer which shows high vertical orientation.

When the saturation magnetization of the Fe—Co-containing soft magnetic particles is lower than 170 Am²/kg, the magnetizing action on the ferromagnetic layer as the upper layer is insufficient, and the vertical orientation of the ferromagnetic layer tends to decrease. Therefore, the saturation magnetization of the soft magnetic particles is preferably made as high as possible. On the other hand, when the saturation magnetization of the Fe—Co-containing soft magnetic particles is too high, the magnetic particles may have decreased stability and their handling may be difficult because of other problem such as ignition or the like. Therefore, the saturation magnetization of the soft magnetic particles is preferably 220 Am²/kg or less. Herein, the coercive force and saturation magnetization of magnetic particles are values corrected with a reference sample after the measurement with a sample vibration magnetometer at 25° C. under the application of a magnetic field of 1,273.3 kA/m.

In general, the Fe—Co-containing soft magnetic particles having such a high saturation magnetization as described above can be prepared by subjecting commercially available Fe—Co-containing soft magnetic particles to a re-reduction treatment since such soft magnetic particles have a saturation magnetization of about 160 Am²/kg. As the re-reduction treatment, either a vapor phase reduction treatment or a liquid phase reduction treatment may be employed. In the case of the vapor phase reduction treatment, a reducing gas such as a hydrogen gas, a carbon monoxide gas or the like may be used. In the case of the liquid phase reduction treatment, a general reducing agent such as sodium borohydride, sodium hypophosphite or the like may be used, or an alcohol-based reducing agent such as polyols may be used. A solvent to be used may be of an aqueous phase or an oil phase. Any of these reduction treatments may be employed in combination: for example, it is possible to carry out a liquid phase reduction treatment under an atmosphere of a reducing gas. In the case of the vapor phase reduction treatment, the reducing temperature is preferably from 420 to 500° C. When the reducing temperature is lower than 420° C., the reduction reaction tends to insufficiently proceed. When the reducing temperature exceeds 500° C., the particles tend to sinter. In the case of the liquid phase reduction treatment, the reducing temperature is preferably from 300 to 550° C. When the reducing temperature is lower than 300° C., the reduction reaction tends to insufficiently proceed. When the reducing temperature exceeds 550° C., the control of the particle size becomes difficult.

The particle size of the Fe—Co-containing soft magnetic particles is preferably from 2 to 30 nm. When the particle size is smaller than 2 nm, the dispersibility of the soft magnetic particles tends to decrease. When the particle size exceeds 30 nm, the fluctuation of the interface between the ferromagnetic layer and the soft magnetic layer tends to increase. The axial ratio of the Fe—Co-containing soft magnetic particles is preferably from 1 to 2. The use of the spherical or ellipsoidal soft magnetic particles with small anisotropy is effective to suppress the degradation of the surface smoothness of the soft magnetic layer during the orientation treatment, which makes it possible for the ferromagnetic layer to have good surface smoothness.

In connection with the Fe—Co-containing soft magnetic particles, the spherical or ellipsoidal shape means a substantially spherical or ellipsoidal shape having a small anisotropy. In the case of ellipsoidal magnetic particles having anisotropy, it means a shape having an axial ratio of the major axis to the minor axis of 2 or less. In the present specification, the particle size and the axial ratio of the magnetic particles are expressed as average values of the particle sizes and the axial ratios of 100 magnetic particles selected from the magnetic particles on a photograph taken with a transmission electron microscope (TEM) at a magnification of 200,000.

The coercive force of the Fe—Co-containing soft magnetic particles is preferably from 2 to 10 kA/m. The use of the Fe—Co-containing magnetic particles having a coercive force in this range prevents a magnetic influence from the soft magnetic layer as the lower layer, which interferes with the orientation of the ferromagnetic particles in the vertical direction. Thus, the ferromagnetic layer showing excellent vertical orientation is obtained. To improve the recording sensitivity and to sharpen the rising of magnetization, the soft magnetic layer preferably has a magnetic permeability of at least 10, more preferably at least 100. The higher magnetic permeability of the soft magnetic layer is more preferable. However, in general, the magnetic permeability of the soft magnetic layer comprising the Fe—Co-containing soft magnetic, particles is up to about 20,000. The magnetic permeability is measured as follows: a measurement sample prepared by forming a single layer of a soft magnetic layer on a nonmagnetic substrate or a measurement sample prepared by forming a soft magnetic layer and a ferromagnetic layer are formed on a nonmagnetic substrate and then peeling the ferromagnetic, layer is used, and the hysteresis loop of the sample is measured using a sample-vibration type magnetometer at 25° C. and an applied magnetic field of 1273.3 kA/m, and corrected with a value for a standard sample. Then, a magnetic permeability is obtained from a slope of the hysteresis loop near the zero magnetic field (−50 Oe to +50 Oe).

The content of the Fe—Co-containing soft magnetic particles in the soft magnetic layer is preferably from 65 to 90%, more preferably from 70 to 85%. A coating type magnetic recording medium comprising magnetic particles dispersed in a binder contains a large amount of nonmagnetic components, and thus it is difficult to increase a saturation magnetic flux density and magnetic permeability in comparison with a magnetic recording medium comprising a thin metal layer. However, the use of the spherical or ellipsoidal Fe—Co-containing soft magnetic particles enables the formation of a soft magnetic layer having a high content of magnetic particles. Therefore, a soft magnetic layer suitable for achieving vertical orientation can be obtained. In the present specification, the content of magnetic particles is a value determined as follows: a scanning electron microscope is used to observe the section of a magnetic layer and to find a difference between the images of secondary electrons and reflected electrons on the section; nonmagnetic components other than the magnetic particles such as a binder, and vacancies in the magnetic layer are specified from such a difference; and such specified amounts are subtracted from the sectional area of the magnetic layer to determine the content of the magnetic particles.

In the present invention, preferably, the Fe—Co-containing soft magnetic particles contain 20 to 50 atomic % of Co relative to Fe, in order to enhance a saturation magnetization. The Fe—Co-containing soft magnetic particles may contain other elements such as a rare earth element, aluminum, silicon, etc., so as to improve the saturation magnetization and corrosion resistance. In particular, Fe—Co-containing soft magnetic particles containing alumina is preferable, since they can form a soft magnetic layer having a high magnetic permeability. When the Fe—Co-containing soft magnetic particles contain aluminum, the content of aluminum is preferably from 2 to 35 atomic %, more preferably from 2 to 31 atomic %, still more preferably from 2 to 13 atomic based on the number of iron and cobalt atoms [100×Al/(Fe+Co)]. When the amount of aluminum is too large, the magnetic permeability of the soft magnetic layer tends to decrease.

Preferably, the thickness of the soft magnetic layer is from 0.1 to 3.5 μm, although not limited thereto. The soft magnetic layer with the thickness in the above range as the lower layer can ensure a magnetizing action of the soft magnetic layer and serves to decrease the entire thickness of the magnetic recording medium.

In the magnetic recording medium of the present invention, the ferromagnetic layer as the upper layer comprises spherical, ellipsoidal or plate-form ferromagnetic particles. To obtain a coating type magnetic recording medium having an axis of easy magnetization in a vertical direction to the magnetic layer, ideally spherical ferromagnetic particles free from anisotropy are used. However, it is essentially difficult to produce ferromagnetic particles with a small axial ratio based on acicular ferromagnetic particles, since the coercive force of the conventional acicular ferromagnetic particles such as iron-based metal magnetic particles depends on magnetic shape anisotropy as described above.

Therefore, in the present invention, spherical, ellipsoidal or plate-form ferromagnetic particles with small anisotropy such as iron nitride-based magnetic particles, Co-based magnetic particles, etc., and plate-form ferromagnetic particles such as barium ferrite-based magnetic particles, etc. are used. A magnetic layer having an axis of easy magnetization in a vertical direction can be obtained by orienting these spherical, ellipsoidal or plate-form ferromagnetic particles in the vertical direction. Among those ferromagnetic particles, the iron nitride-based magnetic particles and the Co-based magnetic particles have a high coercive force, even if they are spherical or ellipsoidal ferromagnetic particles with small anisotropy, because they have excellent crystal magnetic anisotropy. Because of the crystal magnetic anisotropy, the axes of easy magnetization of the particles are arrayed in the vertical direction, and the surface smoothness of the magnetic layer is not degraded even if those ferromagnetic particles are vertically oriented. Thus, the magnetic layer with excellent surface smoothness suitable for high density recording can be obtained. Therefore, even a thin ferromagnetic layer with a thickness of from 3 to 150 nm can maintain excellent surface smoothness. Herein, the spherical, ellipsoidal or plate-form shape means a shape having small anisotropy, such as sphere, ellipsoid, plate, etc. In the case of ellipsoidal or plate-form ferromagnetic particles having anisotropy, their axial ratio is 2 or less.

Preferably, the spherical, ellipsoidal or plate-form ferromagnetic particles have a particle size of from 5 to 50 nm and an axial ratio of from 1 to 2. By the use of such fine ferromagnetic particles, the particle-filling rate of the ferromagnetic layer can be improved to increase an output. When the particle size is smaller than 5 nm, thermal disturbance is induced to degrade the magnetic characteristics of the resultant ferromagnetic layer. When the particle size exceeds 50 nm, the particle-filling rate tends to decrease, and the surface smoothness of the ferromagnetic layer tends to degrade. The particle size means a diameter in the case of spherical ferromagnetic particles, a major axis length in the case of ellipsoidal ferromagnetic particles, or the largest plate size in the case of plate-form ferromagnetic particles. The axial ratio means a ratio of the major axis to the minor axis in the case of ellipsoidal ferromagnetic particles or a ratio of the plate diameter to the smallest plate size in the case of plate-form ferromagnetic particles. In the case of spherical ferromagnetic particles, an axial ratio is “one”.

The BET specific surface area of the ferromagnetic particles is preferably from 40 to 200 m²/g, more preferably at least 50 m²/g, still more preferably at least 60 m²/g. When the BET specific surface area is smaller than 40 m²/g, the coercive force of the ferromagnetic particles tends to decrease. When the BET specific surface area exceeds 200 m²/g, paint dispersibility decreases, or the ferromagnetic particles becomes chemically unstable.

Preferably, the coercive force of the ferromagnetic particles is from 119.4 to 318.5 kA/m, and the saturation magnetization thereof is from 70 to 160 Am²/kg. By the use of the ferromagnetic particles having such a high coercive force and such a high saturation magnetization, a high reproduction output can be obtained during recording with short wavelengths.

When iron nitride-based magnetic particles are used as the ferromagnetic particles in the present invention, iron nitride-based magnetic particles having a Fe₁₆N₂ phase as a main phase are preferable. When a highly crystalline Fe₁₆N₂ phase is contained in the iron nitride-based magnetic particle as the main phase, the coercive force and saturation magnetization of the magnetic particle can be improved. For example, spherical, ellipsoidal or plate-form iron nitride-based magnetic particles having such a Fe₁₆N₂ phase as a main phase are described in, for example, JP-A-2000-277311. Among iron nitride-based magnetic particles of this type, iron nitride-based particles containing 1 to 20 atomic % of nitrogen relative to iron are preferable. In the iron nitride-based magnetic particles, a part of iron may be substituted by other transition metal element. Specific examples of the other transition metal element include Mn, Zn, Ni, Cu, Co, etc. One or more of these transition metal elements may be contained in the iron-nitride-based magnetic particle. Among them, transition metal elements, Co and Ni are preferred, of which Co is particularly preferred since Co is most effective to improve the saturation magnetization of the magnetic particles. However, the content of Co is preferably not larger than 10 atomic % to iron. When the content of Co is too large, a longer time may be required for nitriding.

The iron nitride-based magnetic particle may further contain a rare earth element. Particularly preferable is an iron nitride-based magnetic particle having a two-layered structure which comprises an inner layer containing iron nitride having a Fe₁₆N₂ phase as a main phase, and an outer layer mainly containing the above-described rare earth element, because such an iron nitride-based magnetic particle has high dispersibility and an excellent shape-maintaining property, in spite of its high coercive force. Specific examples of such a rare earth element include yttrium, ytterbium, cesium, praseodymium, lanthanum, europium, neodymium, etc. Each of these rare earth elements may be used alone, or a plurality of them may be used in combination. Among them, yttrium, samarium and neodymium are preferable because they have a high shape-maintaining effect during a reduction reaction. The total content of the rare earth element(s) is preferably from 0.05 to 20 atomic %, more preferably from 0.1 to 15 atomic %, most preferably from 0.5 to 10 atomic %, based on the amount of iron. When the amount of the rare earth element is too small, the dispersibility-improving effect tends to decrease, and the particle shape-maintaining effect during a reduction reaction deteriorates. When the amount of the rare earth element is too large, a portion of an unreacted rare earth element increases, which may interfere with the dispersion of the magnetic particles or a coating operation, or which may cause excessive decrease in coercive force and saturation magnetization.

The iron nitride-based magnetic particle may contain boron, silicon, aluminum and/or phosphorus. The iron nitride-based magnetic particle containing such an element can have high dispersibility. The addition of these elements is advantageous in view of costs, because they are inexpensive as compared with the rare earth elements. The total content of these elements, i.e., boron, silicon, aluminum and phosphorus is preferably from 0.1 to 20 atomic %, based on iron. When the content of these elements is too small, the particle shape-maintaining effect is low. When the content of these elements is too large, the saturation magnetization of the magnetic particles tends to decrease. The iron nitride-based magnetic particle may optionally contain carbon, calcium, magnesium, zirconium, barium, strontium or the like. The use of any of these elements in combination with a rare earth element achieves a higher particle shape-maintaining effect and higher dispersibility.

While a process for manufacturing iron nitride-based magnetic particles is not limited, iron nitride-based magnetic particles can be manufactured by a process described in U.S. Pat. No. 7,233,439 B1, the disclosure of which is herein incorporated by reference in its entirety (corresponding to JP-A-2004-273094). In concrete, an iron oxide or an iron hydroxide is used as a raw material. For example, hematite, magnetite, geothite or the like is used as the iron oxide or the iron hydroxide. The particle size of the raw material is preferably from 5 to 80 nm, more preferably from 5 to 50 nm, still more preferably from 5 to 30 nm, although not limited thereto. When the particle size is too small, particles tend to be sintered during a reduction treatment. When the particle size is too large, a reduction treatment is less uniformly carried out, and the control of the particle size and magnetic characteristics of the resultant iron nitride-based magnetic particles is difficult.

The above-described raw material may be coated with a rare earth element. For example, the raw material is dispersed in an aqueous solution of an alkali or an acid; a salt of a rare earth element is dissolved in the dispersion; and the resulting dispersion is subjected to neutralization or the like to precipitate and deposit a hydroxide or a hydrate containing the rare earth element on the raw material. Alternatively, the raw material may be coated with an element such as boron, silicon, aluminum, phosphorus or the like. For example, a solution of a compound comprising any of the above elements is prepared; and the raw material is immersed in this solution so as to be coated with boron, silicon, aluminum, phosphorus or the like. To efficiently carry out the coating treatment, an additive such as a reducing agent, a pH buffer, a particle size-controlling agent, etc. may be further added to the solution. In the coating treatment, the rare earth element and the element such as boron, silicon, aluminum, phosphorus or the like may be concurrently or alternately coated on the raw material.

Next, the raw material coated as above is heated and reduced in a hydrogen stream. There is no particular limitation on a reducing gas: a reducing gas such as a carbon monoxide gas or the like other than the hydrogen gas may be used. The reducing temperature is desirably from 300 to 600° C. When the reducing temperature is lower than 300° C., the reduction reaction is not likely to sufficiently proceed. When the reducing temperature is higher than 600° C., the particles are likely to be sintered.

After the reduction, a nitriding treatment is carried out to obtain iron nitride-based magnetic particles comprising iron and nitrogen as constituent elements. Preferably, an ammonia-containing gas is used in the nitriding treatment. Besides an ammonia gas, a gas mixture of an ammonia gas with a carrier gas such as a hydrogen gas, a helium gas, a nitrogen gas, an argon gas or the like may be used. The nitrogen gas is particularly preferable because of its cheapness. The nitriding temperature is preferably from 100 to 300° C. When the nitriding temperature is too low, the nitriding does not sufficiently proceed, resulting in a poor effect to increase a coercive force. When the nitriding temperature is too high, the nitriding is excessively accelerated to increase the proportion of a Fe₄N phase or a Fe₃N phase, resulting in a lower coercive force and also the excessive decrease of a saturation magnetization. The conditions for the nitriding treatment are preferably selected so that the content of nitrogen is from 1 to 20 atomic % based on iron. When the content of nitrogen is too small, the amount of a Fe₁₆N₂ phase produced decreases, which leads to a poor coercive force-improving effect. When the content of nitrogen is too large, a Fe₄N phase or a Fe₃N phase is more likely formed, which results in a lower coercive force and also the excessive decrease of a saturation magnetization.

A manufacturing process of the Co-based magnetic particles is not particularly limited, and a conventional electroless deposition process may be used. For example, an aqueous solution containing a cobalt compound such as cobalt chloride, a reducing agent such as sodium hypophosphite, a complexing agent such as sodium citrate, and a particle size-controlling agent such as gelatin is mixed with an aqueous alkaline solution to adjust the pH, and the resulting mixture is mixed with a reaction initiator such as palladium chloride or the like to form Co-based magnetic particles. A manufacturing process of the barium ferrite magnetic particles is not particularly limited, and a conventional glass crystallization process and the like may be used. For example, barium oxide, iron oxide, a metal oxide for substituting iron and a glass-forming material such as boron oxide, etc. are mixed in such amounts that a desirable ferrite composition is attained, the mixture is molten and then quenched and reheated. Thereafter, the mixture is washed and milled to obtain barium ferrite magnetic particles.

The content of the spherical, ellipsoidal or plate-form ferromagnetic particles in the ferromagnetic layer is preferably from 40 to 90%, more preferably from 46 to 81%. The ferromagnetic layer having a high content of the ferromagnetic particles has an improved magnetic flux density.

The magnetic recording medium of the present invention comprises, as the lower layer, the soft magnetic layer containing the spherical or ellipsoidal Fe—Co-containing soft magnetic particles having a low coercive force and high saturation magnetization, and the ferromagnetic layer containing the spherical, ellipsoidal or plate-form ferromagnetic particles suitable for vertical orientation, which is formed on the soft magnetic layer. Therefore, the spherical, ellipsoidal or plate-form ferromagnetic particles contained in a paint for the ferromagnetic layer to be applied as the upper layer can be efficiently oriented in a magnetic field. Accordingly, the ferromagnetic layer can have both a high vertical orienting property of from 0.70 to 0.98 and excellent surface smoothness. According to the present invention, it is also possible to form a ferromagnetic layer having a high orienting property of from 0.88 to 0.98, and it is therefore possible to provide a magnetic recording medium suitable for recording with short wavelengths. Ideally, the squareness in the vertical direction is one (1), that is, the axes of easy magnetization of all the ferromagnetic particles are directed in the vertical direction. However, ferromagnetic particles such as iron-nitride-based magnetic particles and Co-based magnetic particles include some ferromagnetic particles shaped ellipsoidal or the like having a certain anisotropy. Consequently, the axes of easy magnetization of such ferromagnetic particles are sometimes inclined obliquely from the vertical direction by the mechanical orientation during a coating operation. For this reason, the ferromagnetic layer of the present invention has an axis of easy magnetization substantially in a vertical direction, wherein the squareness in the vertical direction is from 0.70 to 0.98. Herein, the squareness of the ferromagnetic layer is a value measured with a vertical Kerr rotational angle meter (external magnetic field: 127 kA/m). When the squareness is measured with a sample vibration magnetometer, the squareness of a magnetic recording medium comprising an upper magnetic layer with a thin thickness shows a larger value than an intrinsic value. For this reason, the squareness in the vertical direction can be correctly measured by measuring the vertical Kerr rotation.

The coercive force of the ferromagnetic layer in the vertical direction is preferably from 80 to 320 kA/m. When the coercive force is smaller than the lower limit, it may be difficult to obtain a high output during recording with short wavelengths. When the coercive force is larger than the upper limit, it may be difficult to perform saturation recording with a magnetic head.

The thickness of the ferromagnetic layer is preferably from 5 to 150 nm, more preferably from 15 to 150 nm. The ferromagnetic layer with a thickness within this range can effectively increase a reproduction output in short wavelength recording. When this thickness is smaller than 5 nm, uniform coating is impossible. When this thickness is larger than 150 nm, self-demagnetization loss and thickness loss in short wavelength recording increases, which results in a lower output and lower resolution.

Hereinafter, components suitable for use in the nonmagnetic substrate, the ferromagnetic layer and the soft magnetic layer other than the magnetic particles, and methods for preparing the respective paints, and methods for applying the respective paints will be explained. Further, the structure of a nonmagnetic layer to be provided between the nonmagnetic substrate and the soft magnetic layer, and the structure of a backcoat layer will be explained below.

### Nonmagnetic Substrate

As the nonmagnetic substrate, any of the conventional nonmagnetic substrates for magnetic recording media can be used. Examples thereof include plastic films with a thickness of usually from 2 to 15 μm, particularly from 2 to 7 μm, made of polyesters such as polyethylene terephthalate and polyethylene naphthalate, polyolefins, cellulose triacetate, polycarbonate, polyamide, polyimide, polyamideimide, polysulfone, aramid, aromatic polyamide, etc.

### Ferromagnetic Layer

As a binder for use in the ferromagnetic layer, for example, at least one resin selected from the group consisting of vinyl chloride resins, nitrocellulose resins, epoxy resins and polyurethane resins is used. Specific examples of the vinyl chloride resins include vinyl chloride resins, vinyl chloride-vinyl acetate copolymer resins, vinyl chloride-vinyl alcohol copolymer resins, vinyl chloride-vinyl acetate-vinyl alcohol copolymer resins, vinyl chloride-vinyl acetate-maleic anhydride copolymer resins, vinyl chloride-hydroxyl group-containing alkyl acrylate copolymer resins, etc. Among them, a blend of a vinyl chloride resin and a polyurethane resin is preferable, and a blend of a vinyl chloride-hydroxyl group-containing alkyl acrylate copolymer resin and a polyurethane resin is more preferable. These binders preferably have a functional group in order to improve the dispersibility of the particles and to increase the filling rate. Specific examples of such a functional group include a group of the formula: COOM, SO₃M, OSO₃M, P=O(OM)₃ or O—P=O(OM)₂ (in which M is a hydrogen atom, an alkali metal salt or an amine salt), a group of the formula: OH, NR¹R² or NR³R⁴R⁵ (in which, each of R¹, R², R³, R⁴ and R⁵ is a hydrogen atom or a hydrocarbon group usually having 1 to 10 carbon atoms), an epoxy group, etc. When two or more binder resins are used in combination, the functional groups of the resins preferably have the same polarity. Above all, the combination of the resins both having —SO₃M groups is preferable. The binder is used in an amount of from 7 to 50 parts by weight, preferably from 10 to 35 parts by weight, per 100 parts by weight of the ferromagnetic particles. Especially preferable is the use of 5 to 30 parts by weight of a vinyl chloride resin in combination with 2 to 20 parts by weight of a polyurethane resin.

It is also preferable to use the binder in combination with a thermocurable crosslinking agent which is bound to the functional group of the binder to form a crosslinked structure. Examples of the crosslinking agent include isocyanate compounds such as tolylene diisocyanate, hexamethylene diisocyanate, isophorone diisocyanate, etc.; reaction products of isocyanate compounds with compounds having a plurality of hydroxyl groups, such as trimethylolpropane, etc.; and various polyisocyanates such as condensed products of isocyanate compounds. The crosslinking agent is used in an amount of usually from 10 to 50 parts by weight per 100 parts by weight of the binder.

Preferably, the ferromagnetic layer contains carbon black and a lubricant in order to improve the electric conductivity and surface lubricity of the layer. Specific examples of carbon black include acetylene black, furnace black and thermal black. The average particle size of carbon black is preferably from 5 to 200 nm, more preferably from 10 to 100 nm. The content of carbon black is preferably from 0.2 to 5 parts by weight, more preferably from 0.5 to 4 parts by weight, per 100 parts by weight of the ferromagnetic particles. Specific examples of the lubricant include fatty acids, fatty esters, fatty amides, etc. each having 10 to 30 carbon atoms. These lubricants may be used alone or in combination of two or more of them. The content of the lubricant is preferably from 0.2 to 3 parts by weight per 100 parts by weight of the ferromagnetic particles.

To improve the durability and running performance of the magnetic recording medium, nonmagnetic particles such as alumina, silica or the like may be added to the ferromagnetic layer. The content of such nonmagnetic particles is preferably from 1 to 20 parts by weight per 100 parts by weight of the ferromagnetic particles.

The surface roughness (Ra) of the ferromagnetic layer is preferably from 1.0 to 3.2 nm. The magnetic recording medium of the present invention comprises the lower layer containing the spherical or ellipsoidal Fe—Co-containing soft magnetic particles having a low coercive force and a high saturation magnetization, and the upper layer containing the spherical, ellipsoidal or plate-form ferromagnetic particles having a high coercive force and a high saturation magnetization. Therefore, the ferromagnetic layer having a very smooth surface can be obtained despite the vertical orientation treatment, as described above. Accordingly, the contact between the magnetic record medium and a magnetic head is improved and thus a higher reproduction output is obtained. The average surface roughness is a value found by measurement with a three dimensional surface structure analyzer (“NewView 5000 manufactured by ZYGO) by a scanning white-light interferometry (scan length: 5 μm; and measuring view field: 350 μm×260 μm).

### Soft Magnetic Layer

As a binder for use in the soft magnetic layer, the same binder as that used in the ferromagnetic layer may be used. The content of the binder is preferably from 7 to 50 parts by weight, more preferably from 10 to 35 parts by weight per 100 parts by weight of the Fe—Co-containing soft magnetic particles.

Preferably, the soft magnetic layer contains carbon black and a lubricant in order to impart electric conductivity and a surface lubricity to the ferromagnetic layer. Such carbon black and lubricant may be the same as those used in the ferromagnetic layer. The content of the carbon black is preferably from 15 to 35 parts by weight, more preferably from 20 to 30 parts by weight, per 100 parts by weight of the Fe—Co-containing soft magnetic particles. The content of the lubricant is preferably from 0.7 to 7 parts by weight per 100 parts by weight of the Fe—Co-containing soft magnetic particles. Preferably, a fatty acid and a fatty acid ester are preferably used in combination.

The soft magnetic layer may further contain nonmagnetic particles similar to those for use in the ferromagnetic layer. When the soft magnetic layer contains such nonmagnetic particles, adhesion between the soft magnetic layer and the ferromagnetic layer can be improved.

### Methods for Preparing Paints and Coating Methods

Paints for the ferromagnetic layer and the soft magnetic layer may be prepared by any of the methods for preparing paints which are conventionally employed in the production of magnetic recording media. In concrete, such a method preferably comprises a kneading step using a kneader or the like, and a primary dispersing step using a sand mill, a pin mill or the like, in combination. The paints for the ferromagnetic layer and the soft magnetic layer may be applied to the nonmagnetic substrate by any coating method, such as gravure coating, roll coating, blade coating, extrusion coating or the like, which are conventionally employed in the production of magnetic recording media. The application of the paints for the ferromagnetic layer and the soft magnetic layer may be done by either one of a sequential superposing application method and a concurrent superposing application method (a wet-on-wet method).

In the present invention, a magnetic field is applied vertically to the paint which is still in a wet state, during the coating step to carry out an orientation treatment so that the axis of easy magnetization of the ferromagnetic layer is directed substantially in a vertical direction. In this orientation treatment, solenoid magnets, permanent magnets, etc. may be used. The strength of the magnetic field is preferably from 0.05 to 1 T, so as to suppress the degradation of the surface roughness of the ferromagnetic layer.

### Nonmagnetic Layer

The magnetic recording medium of the present invention may have a nonmagnetic layer comprising nonmagnetic particles and a binder between the nonmagnetic substrate and the soft magnetic layer in order to improve the surface smoothness and to control the viscosity of the paint and the rigidity of the tape. The thickness of the nonmagnetic layer is preferably from 0.1 to 3.0 μm, more preferably from 0.15 co 2.5 μm. Specific examples of the nonmagnetic particles are nonmagnetic particles of titanium oxide, iron oxide, aluminum oxide and the like. These nonmagnetic particles may be used alone, or some of them may be used as a mixture. In order to impart electric conductivity to the layer, carbon black such as acetylene black, furnace black, thermal black or the like may be used. As the binder, the same binder as that for use in the ferromagnetic layer may be used. The content of the binder is preferably from 7 to 50 parts by weight, more preferably from 10 to 35 parts by weight, per 100 parts by weight of the nonmagnetic particles. The nonmagnetic layer may be formed at the same time as the formation of the soft magnetic layer and the ferromagnetic layer. Alternatively, the nonmagnetic layer is formed, and then, the soft magnetic layer and the ferromagnetic layer are sequentially or simultaneously formed on the nonmagnetic layer.

### Backcoat Layer

The magnetic recording medium of the present invention may have a backcoat layer. The thickness of the backcoat layer is preferably form 0.2 to 0.8 μm, more preferably from 0.3 to 0.8 μm. The backcoat layer preferably contains carbon black such as acetylene black, furnace black, thermal black or the like. As a binder for use in the backcoat layer, the same binder as that for use in the ferromagnetic layer may be used. Above all, a combination of a cellulose resin and a polyurethane resin is preferably used in order to decrease a friction coefficient and to improve the running performance of the resultant recording medium. The content of the binder is preferably from 40 to 150 parts by weight, more preferably from 50 to 120 parts by weight, per 100 parts by weight of the particles. The backcoat layer may be formed prior to the formation of the soft magnetic layer and the ferromagnetic layer, or may be formed after the formation of the soft magnetic layer and the ferromagnetic layer.

### Surface Treatment

The magnetic recording medium produced by the method described above may optionally be subjected to a surface treatment such as a lapping treatment, a rotary treatment, a tissuing treatment or the like. By subjecting the magnetic recording medium to such a surface treatment, the surface smoothness thereof and the friction coefficient thereof to a head or a cylinder can be optimized. As a result, the running performance and the reproduction output of the recording medium are improved, and the spacing loss is reduced.

Hereinafter, the present invention will be described in more detail by the Examples which, however, should not be construed as limiting the scope of the present invention in any way. In the following Examples, “parts” are “parts, by weight”, unless otherwise specified.

### EXAMPLES

### Preparation of Fe—Co-Containing Soft Magnetic Particles

Fe—Co-containing soft magnetic particles (a) (Co/Fe: 43 atomic %; added element: Al; Al/(Fe+Co): 13 atomic %; saturation magnetization: 158 Am²/kg; coercive force: 8 kA/m; particle shape: sphere; particle size: 12 nm; and axial ratio: 1.1);

Fe—Co-containing soft magnetic particles (b) (Co/Fe: 43 atomic %; added element: Al; Al/(Fe+Co): 6 atomic %; saturation magnetization: 155 Am²/kg; coercive force: 8 kA/m; particle shape: sphere; particle size: 12 nm; and axial ratio: 1.1);

Fe—Co-containing soft magnetic particles (c) (Co/Fe: 43 atomic %; added element: Al; Al/(Fe+Co): 2 atomic %; saturation magnetization: 148 Am²/kg; coercive force: 8 kA/m; particle shape: sphere; particle size: 12 nm; and axial ratio: 1.1); and

Fe—Co-containing soft magnetic particles (d) (Co/Fe: 43 atomic %; added element: Al; Al/(Fe+Co): 31 atomic %; saturation magnetization: 158 Am²/kg; coercive force: 8 kA/m; particle shape: sphere; particle size: 12 nm; and axial ratio: 1.1)

were provided and subjected to a re-reduction treatment in a stream of a hydrogen gas under the conditions indicated in TABLE 1 below, to obtain respective Fe—Co-containing soft magnetic particles. When the Fe—Co-containing soft magnetic particles (a) were subjected to the re-reduction treatment at a reducing temperature of 495° C. for 2.5 hours to obtain Fe—Co-containing soft magnetic particles having saturation magnetization of 230 Am²/kg, the handling of the resultant soft magnetic particles in an air was difficult because of heat evolution.

TABLE 1

| Fe—Co-cont. | | Re-reduction | | | | | | | | | |
|---|---|---|---|---|---|---|---|---|---|---|---|
| soft | | treatment | | | | | Saturation | Coercive | | particle | |
| magnetic | Raw | Yes/ | Temp. | Time | Co/Fe | Al/(Fe + Co) | magnetization | force | | size | Axial |
| particles | material | No | (° C.) | (hr.) | (atom. %) | (atom. %) | (Am²/kg) | (kA/m) | Shape | (nm) | ratio |
| P-1 | (a) | Yes | 485 | 2.5 | 43 | 13 | 205 | 8 | Sphere | 9 | 1.1 |
| P-2 | (a) | Yes | 455 | 1.5 | 43 | 13 | 173 | 7 | Sphere | 11 | 1.1 |
| P-3 | (a) | Yes | 490 | 1.5 | 43 | 13 | 215 | 8 | Sphere | 9 | 1.1 |
| P-4 | (a) | No | — | — | 43 | 13 | 158 | 8 | Sphere | 12 | 1.1 |
| P-5 | (b) | Yes | 485 | 2.5 | 43 | 6 | 205 | 8 | Sphere | 9 | 1.1 |
| P-6 | (c) | Yes | 485 | 2.5 | 43 | 2 | 205 | 8 | Sphere | 9 | 1.1 |
| P-7 | (d) | Yes | 485 | 2.5 | 43 | 31 | 191 | 8 | Sphere | 9 | 1.1 |

### <Preparation of Iron-Nitride-Based Magnetic Particles>

Iron (II) sulfate heptahydrate (116 parts) and iron (III) nitrate nonahydrate (547 parts) were dissolved in water (1,500 parts). Separately, sodium hydroxide (150 parts) was dissolved in water (1,500 parts). To the above aqueous solution of the two kinds of salts of iron, the aqueous solution of sodium hydroxide was added, and then the mixture was stirred for 20 minutes to form magnetite particles. The obtained magnetite particles were charged in an autoclave and heated at 200° C. for 4 hours. The resulting magnetite particles were subjected to a hydrothermal treatment, washed with water and dried to obtain substantially spherical or ellipsoidal magnetite particles with a particle size of 25 nm.

The magnetite particles produced in the previous step (10 parts) were dispersed in water (500 parts) for 30 minutes with an ultrasonic disperser. Yttrium nitrate (2.5 parts) was added to and dissolved in this liquid dispersion, and the resulting solution was stirred for 30 minutes. Separately, sodium hydroxide (0.8 part) was dissolved in water (100 parts). This aqueous sodium hydroxide solution was dropwise added to the above dispersion over about 30 minutes. After completion of the addition, the mixture was further stirred for one hour. By this treatment, yttrium hydroxide was deposited and coated on the surfaces of the magnetite particles. The resultant coated magnetite particles were washed with water, filtered and dried at 90° C. to obtain magnetite particles coated with yttrium hydroxide on their surfaces.

The magnetite particles coated with yttrium hydroxide on their surfaces were reduced by heating at 450° C. for 2 hours in a stream of a hydrogen gas to obtain yttrium-containing iron-based magnetic particles. Next, the obtained magnetic particles were cooled to 150° C. over about one hour while flowing the hydrogen gas. When the magnetic particles were cooled to 150° C., the hydrogen gas was switched to an ammonia gas, and the magnetic particles maintained at 150° C. were nitrided for 30 hours. After that, the magnetic particles were cooled from 150° C. to 90° C. while flowing the ammonia gas, and then, at 90° C., the ammonia gas was switched to a gas mixture of an oxygen gas and a nitrogen gas, followed by stabilization of the magnetic particles for 2 hours. Then, the magnetic particles were cooled from 90° C. to 40° C. and maintained at 40° C. for about 10 hours while flowing the gas mixture, and then were taken out into an air to obtain iron nitride-based magnetic particles (N-1).

The contents of yttrium and nitrogen based on iron in the iron nitride-based magnetic particle thus obtained were measured by means of fluorescent X-ray analysis. As a result, the contents of yttrium and nitrogen were 5.3 atomic % and 10.8 atomic %, respectively. A profile indicating a Fe₁₆N₂ phase was observed from, an X-ray diffraction pattern of the magnetic particles. The shapes of the magnetic particles were observed with a high-resolution analytical transmission electron microscope. As a result, it was confirmed that the iron nitride-based magnetic particles were substantially spherical, having, a particle size of 20 nm and an axial ratio of 1.1. The specific surface area thereof determined by the BET method was 53.2 m²/g. The magnetic characteristics of the iron nitride-based magnetic particles were measured. As a result, the saturation magnetization was 135.2 Am²/kg, and the coercive force was 226.9 kA/m.

### <Preparation of Co-Based Magnetic Particles>

CoCl₂·6H₂O (13 parts), NaPH₂O₂·H₂O (20 parts), C₆H₅O₇Na₃·2H₂O (30 parts), H₃BO₃ (15 parts) and gelatin (10 parts) were dissolved in water (1,000 parts). This aqueous solution was adjusted to pH of 8.3 with a 10N aqueous sodium hydroxide solution, and then heated to 85° C. After heating, PbCl₂ (one part) was dropwise added to the aqueous solution, and the mixture was reacted for 45 minutes. After completion of the reaction, Co-based magnetic particles formed in the aqueous solution were recovered with magnets, and were washed with water and dried to obtain Co-based magnetic particles (C-1).

The shapes of the Co-based magnetic particles thus obtained were observed with the high-resolution analytical transmission electron microscope. As a result, it was confirmed that the particles were substantially spherical, having a particle size of 20 nm and an axial ratio of 1.1. The specific surface area thereof determined by the BET method was 53.2 m²/g. The magnetic characteristics of the Co-based magnetic particles were measured. As a result, the saturation magnetization was 110 Am²/kg, and the coercive force was 127 kA/m.

### <Production of Magnetic Recording Medium>

### Example 1

### Preparation of Paint for Nonmagnetic Layer

The components of a paint for a nonmagnetic layer shown in TABLE 2 below were kneaded with a kneader, and the mixture was dispersed with a sand mill (residence time: 60 minutes), and polyisocyanate (6 parts) was added thereto. The mixture was stirred and filtered to prepare a paint for a nonmagnetic layer.

TABLE 2

| Components of Paint for Nonmagnetic Layer | Amount | |
|---|---|---|
| Iron oxide particles (av. particle size: 55 nm) | 70 | parts |
| Alumina particles (av. particle size: 80 nm) | 10 | parts |
| Carbon black (av. particle size: 25 nm) | 20 | parts |
| Vinyl chloride-hydroxypropyl methacrylate copolymer | 10 | parts |
| resin (contained —SO₃Na groups: 0.7 × 10⁻⁴ eq./g) | | |
| Polyester polyurethane resin | 5 | parts |
| (contained —SO₃Na groups: 1.0 × 10⁻⁴ eq./g) | | |
| Methyl ethyl ketone | 130 | parts |
| Toluene | 80 | parts |
| Cyclohexanone | 65 | parts |
| Myristic acid | 1 | part |
| Butyl stearate | 1.5 | parts |

### <Preparation of Paint for Soft Magnetic Layer>

The components of a paint for a soft magnetic layer shown in TABLE 3 below were kneaded with a kneader and then were dispersed with a sand mill (residence time: 60 minutes), and polyisocyanate (6 parts) was added thereto. The mixture was stirred and filtered to obtain a paint for a soft magnetic layer.

TABLE 3

| Components of paint for soft magnetic layer | Amount | |
|---|---|---|
| Above-described Fe—Co-containing magnetic particles | 85 | parts |
| (P-1) | | |
| Vinyl chloride-hydroxypropyl methacrylate copolymer | 10 | parts |
| resin (contained —SO₃Na groups: 0.7 × 10⁻⁴ eq./g) | | |
| Polyester polyurethane resin | 5 | parts |
| (contained —SO₃Na groups: 1.0 × 10⁻⁴ eq./g) | | |
| Methyl ethyl ketone | 100 | parts |
| Toluene | 100 | parts |
| Myristic acid | 1 | part |
| Butyl stearate | 1.5 | parts |

### <Preparation of Paint for Ferromagnetic Layer>

The components (1) of a paint for a ferromagnetic layer shown in TABLE 4 below were kneaded with a kneader and then dispersed with a sand mill (residence time: 60 minutes), and the components (2) of the paint for the ferromagnetic layer shown in TABLE 5 below were added to the resulting dispersion. The mixture was stirred and filtered to obtain a paint for a ferromagnetic layer.

TABLE 4

| Components (1) of paint for ferromagnetic layer | Amount | |
|---|---|---|
| Above-described iron nitride-based magnetic particles | 100 | parts |
| (N-1) | | |
| α-Alumina (average particle size: 80 nm) | 10 | parts |
| Carbon black (average particle size: 25 nm) | 1.5 | parts |
| Vinyl chloride-hydroxypropyl methacrylate copolymer | 10 | parts |
| resin (contained —SO₃Na groups: 0.7 × 10⁻⁴ eq./g) | | |
| Polyester polyurethane resin | 5 | parts |
| (contained —SO₃Na groups: 1.0 × 10⁻⁴ eq./g) | | |
| Methyl ethyl ketone | 116 | parts |
| Toluene | 116 | parts |
| Myristic acid | 1 | part |
| Butyl stearate | 1.5 | parts |

TABLE 5

| Components (2) of paint for ferromagnetic layer | Amount | |
|---|---|---|
| Stearic acid | 1.5 | parts |
| Polyisocyanate | 5 | parts |
| Cyclohexanone | 133 | parts |
| Toluene | 33 | parts |

### <Coating and Orientation Treatment>

First, the paint for the nonmagnetic layer was applied to a polyethylene terephthalate film (thickness: 6 μm) as a nonmagnetic substrate, and then dried and calendered to form a nonmagnetic layer with a thickness of 2 μm.

Next, the paint for the soft magnetic layer and the paint for the ferromagnetic layer were concurrently applied to the nonmagnetic layer formed in the previous step, and then dried and calendered to form a soft magnetic layer with a thickness of 0.6 μm and a ferromagnetic layer with a thickness of 150 nm, respectively. During the application of the paints, a vertical orientation treatment was carried out by conveying the nonmagnetic substrate between a pair of permanent magnets which were disposed with their N poles and S poles opposed to each other in the thickness direction of the nonmagnetic substrate (a magnetic field strength: 0.8 T).

### <Formation of Backcoat Layer>

The components of a paint for a backcoat layer shown in TABLE 6 below were dispersed with a sand mill (residence time: 45 minutes), and polyisocyanate (8.5 parts) was added thereto. The mixture was stirred and filtered to obtain a paint for a backcoat layer.

TABLE 6

| Components of paint for backcoat layer | Amount | |
|---|---|---|
| Carbon black (average particle size: 25 nm) | 40.5 | parts |
| Carbon black (average particle size: 370 nm) | 0.5 | part |
| Barium sulfate | 4.05 | parts |
| Nitrocellulose | 28 | parts |
| Polyurethane resin (containing —SO₃Na groups) | 20 | parts |
| Methyl ethyl ketone | 100 | parts |
| Toluene | 100 | parts |
| Cyclohexanone | 100 | parts |

The above-described paint for a backcoat layer was applied to the other surface of the nonmagnetic substrate which had the magnetic layer formed on its one surface, and then dried and calendered to form a backcoat layer with a thickness of 700 nm.

### <Calendering and Slitting>

A magnetic sheet consisting of the nonmagnetic substrate, the soft magnetic layer and the ferromagnetic layer formed on one surface of the nonmagnetic substrate, and the backcoat layer formed on the other surface thereof as described above was mirror-finished with a five-staged calender (temperature: 70° C.; linear pressure: 150 Kg/cm), and was wound around a sheet core. The wound magnetic sheet was aged for 48 hours at 60° C. and 40% RH. After that, the magnetic sheet was slit to form strips with a width of ½ inch. Thus, a magnetic tape was obtained.

### Example 2

A magnetic tape was produced in the same manner as in Example 1, except that Fe—Co-containing soft magnetic particles (P-2) were used instead of the Fe—Co-containing soft magnetic particles (P-1) in the preparation of the paint for the soft magnetic layer of Example 1.

### Example 3

A magnetic tape was produced in the same manner as in Example 1, except that Fe—Co-containing soft magnetic particles (P-3) were used instead of the Fe—Co-containing soft magnetic particles (P-1) in the preparation of the paint for the soft magnetic layer of Example 1.

### Example 4

A magnetic tape was produced in the same manner as in Example 1, except that the amount of the Fe—Co-containing soft magnetic particles (P-1) was changed to 40 parts in the preparation of the paint for the soft magnetic layer of Example 1.

### Example 5

A magnetic tape was produced in the same manner as in Example 1, except that the amount of the Fe—Co-containing soft magnetic particles (P-1) was changed to 100 parts in the preparation of the paint for the soft magnetic layer of Example 1.

### Example 6

A magnetic tape was produced in the same manner as in Example 1, except that the amount of the iron nitride-based magnetic particles (N-1) was changed to 30 parts in the preparation of the paint for the ferromagnetic layer of Example 1.

### Example 7

A magnetic tape was produced in the same manner as in Example 1, except that the amount of the iron nitride-based magnetic particles (N-1) was changed to 150 parts in the preparation of the paint for the ferromagnetic layer of Example 1.

### Example 8

A magnetic tape was produced in the same manner as in Example 1, except that the magnetic field strength was changed to 0.06 T in the coating and orientation treatment in Example 1.

### Example 9

A magnetic tape was produced in the same manner as in Example 1, except that the magnetic field strength was changed to 1 T in the coating and orientation treatment in Example 1.

### Example 10

A magnetic tape was produced in the same manner as in Example 1, except that the thickness of the ferromagnetic layer was changed to 15 nm in the coating and orientation treatment in Example 1.

### Example 11

A magnetic tape was produced in the same manner as in Example 1, except that Co-based magnetic particles (C-1) were used instead of the iron nitride-based magnetic particles (N-1) in the preparation of the paint for the ferromagnetic layer of Example 1.

### Example 12

A magnetic tape was produced in the same manner as in Example 1, except that Fe—Co-containing soft magnetic particles (P-5) were used instead of the Fe—Co-containing soft magnetic particles (P-1) in the preparation of the paint for the soft magnetic layer of Example 1.

### Example 13

A magnetic tape was produced in the same manner as in Example 1, except that Fe—Co-containing soft magnetic particles (P-6) were used instead of the Fe—Co-containing soft magnetic particles (P-1) in the preparation of the paint for the soft magnetic layer of Example 1.

### Example 14

A magnetic tape was produced in the same manner as in Example 1, except that Fe—Co-containing soft magnetic particles (P-7) were used instead of the Fe—Co-containing soft magnetic particles (P-1) in the preparation of the paint for the soft magnetic layer of Example 1.

### Example 15

A magnetic tape was produced in the same manner as in Example 1, except that barium ferrite magnetic particles (added element: Co; saturation magnetization: 38.8 Am²/kg; coercive force: 144.1 kA/m; particle shape: plate; particle size: 22 nm; and axial ratio: 1; plate thickness 7 nm) (B-1) were used instead of the iron nitride-based ferromagnetic particles (N-1) in the preparation of the paint for the ferromagnetic layer of Example 1.

### Comparative Example 1

A magnetic tape was produced in the same manner as in Example 1, except that Fe—Co-containing soft magnetic particles (P-4) were used instead of the Fe—Co-containing soft magnetic particles (P-1) in the preparation of the paint for the soft magnetic layer of Example 1.

### Comparative Example 2

A magnetic tape was produced in the same manner as in Example 1, except that Mn—Zn ferrite soft magnetic particles (F-1) (saturation magnetization: 62 Am²/kg; coercive force: 8 kA/m; particle shape: spherical; and particle size: 40 nm) were used instead of the Fe—Co-containing soft magnetic particles (P-1) in the preparation of the paint for the soft, magnetic layer of Example 1.

### Comparative Example 3

A magnetic tape was produced in the same manner as in Example 1, except that Co-based magnetic particles (C-1) were used instead of the iron nitride-based magnetic particles (N-1) in the preparation of the paint for the ferromagnetic layer of Example 1, and that Fe—Co-containing soft magnetic particles (P-4) were used instead of the Fe—Co-containing soft magnetic particles (P-1) in the preparation of the paint for the soft magnetic layer.

### Comparative Example 4

A magnetic tape was produced in the same manner as in Example 1, except that the thickness of the ferromagnetic layer was changed to 200 nm in the coating and orientation treatment in Example 1.

With each of the magnetic tapes produced in the Examples and the Comparative Examples, a squareness in the vertical direction, a magnetic permeability, contents of the magnetic particles in the ferromagnetic layer and the soft magnetic layer, and surface roughness of the ferromagnetic layer were measured. Also, with each of the magnetic tapes, reproduction output and resolution were evaluated by the following methods. The results are shown in TABLES 7 and 8.

### <Electromagnetic Conversion Characteristics>

A drum tester equipped with an electromagnetic induction type head (track width: 25 μm; and gap length: 0.23 μm) and a MR head (gap length: 0.17 μm) was used to evaluate electromagnetic characteristics. A magnetic tape with a length of about 60 cm as a test sample was wound around the rotary drum of the drum tester. Signals were recorded on the magnetic tape using the induction type head, and the recorded signals were reproduced using the MR head. The heads were set on different sites in relation to the rotary drum, and moved in the vertical direction to match tracking. A reproduction output was measured as follows: a function generator was used to write rectangular wave signals with a wavelength of 0.1 μm on the magnetic tape to evaluate a reproduction output within a short wavelength region, and the recorded signals were reproduced using the MR head; and an output found during the reproduction with the MR head was read with a spectrum analyzer to measure the output. In this regard, the reproduction outputs of the respective magnetic tapes were recorded as relative values relative to the reproduction output of the magnetic tape of Comparative Example 2, which was regarded as 100%. The resolutions of the respective magnetic tapes were measured as follows: the function generator was used to write rectangular wave-form signals with a wavelength of 10 μm on the magnetic tape; and the output from the MR head was read with a digital oscilloscope, and then the peak width at half height (PW50) of a solitary waveform was converted to a length, which was recorded. Here, the resolutions of the respective magnetic tapes were evaluated as relative values, in relation to the PW50 of the magnetic tape of Comparative Example 2, which was regarded as 100%.

TABLE 7

| | | E. 1 | E. 2 | E. 3 | E. 4 | E. 5 | E. 6 | E. 7 | E. 8 | E. 9 | E. 10 |
|---|---|---|---|---|---|---|---|---|---|---|---|
| Soft | Soft magnetic | P-1 | P-2 | P-3 | P-1 | P-1 | P-1 | P-1 | P-1 | P-1 | P-1 |
| magnetic | particle | | | | | | | | | | |
| layer | Content (%) | 82.9 | 82.9 | 82.9 | 69.6 | 85.1 | 82.9 | 82.9 | 82.9 | 82.9 | 82.9 |
| | Magnetic | 25 | 25 | 25 | 25 | 25 | 25 | 25 | 25 | 25 | 25 |
| | permeability | | | | | | | | | | |
| Ferromagnetic | Ferromagnetic | N-1 | N-1 | N-1 | N-1 | N-1 | N-1 | N-1 | N-1 | N-1 | N-1 |
| layer | particle | | | | | | | | | | |
| | Thickness (nm) | 150 | 150 | 150 | 150 | 150 | 150 | 150 | 150 | 150 | 15 |
| | Squareness | 0.94 | 0.92 | 0.96 | 0.94 | 0.94 | 0.94 | 0.71 | 0.94 | 0.96 | 0.94 |
| | Content (%) | 73.8 | 73.8 | 73.8 | 73.8 | 73.8 | 45.8 | 80.9 | 73.8 | 73.8 | 73.8 |
| | Ra (nm) | 2.1 | 2.1 | 2.1 | 2.1 | 2.1 | 2.1 | 2.1 | 2.3 | 2.1 | 1.8 |

| | | | | | | | | | | |
|---|---|---|---|---|---|---|---|---|---|---|
| Reproduction output (%) | 120 | 129 | 131 | 107 | 133 | 103 | 130 | 117 | 125 | 102 |
| Resolution (%) | 63 | 61 | 59 | 71 | 58 | 55 | 76 | 69 | 60 | 57 |

TABLE 8

| | | E. 11 | E. 12 | E. 13 | E. 14 | E. 15 | C. E. 1 | C. E. 2 | C. E. 3 | C. E. 4 |
|---|---|---|---|---|---|---|---|---|---|---|
| Soft | Soft magnetic | P-1 | P-5 | P-6 | P-7 | P-1 | P-4 | F-1 | P-4 | P-1 |
| magnetic | particle | | | | | | | | | |
| layer | Content (%) | 82.9 | 82.9 | 82.9 | 82.9 | 82.9 | 82.9 | 82.9 | 82.9 | 82.9 |
| | Magnetic | 25 | 110 | 24 | 12 | 25 | 20 | 21 | 20 | 25 |
| | permeability | | | | | | | | | |
| Ferromagnetic | Ferromagnetic | C-1 | N-1 | N-1 | N-1 | B-1 | N-1 | N-1 | C-1 | N-1 |
| layer | particle | | | | | | | | | |
| | Thickness (nm) | 150 | 150 | 150 | 150 | 150 | 150 | 150 | 150 | 200 |
| | Squareness | 0.88 | 0.94 | 0.94 | 0.94 | 0.90 | 0.67 | 0.65 | 0.65 | 0.9 |
| | Content (%) | 73.8 | 73.8 | 73.8 | 73.8 | 73.8 | 73.8 | 73.8 | 73.8 | 73.8 |
| | Ra (nm) | 2.3 | 2.1 | 2.1 | 2..1 | 2.4 | 3.1 | 2.1 | 2.4 | 2.0 |

| | | | | | | | | | |
|---|---|---|---|---|---|---|---|---|---|
| Reproduction output (%) | 108 | 120 | 121 | 119 | 104 | 101 | 101 | 100 | 97 |
| Resolution (%) | 89 | 51 | 63 | 79 | 76 | 99 | 99 | 99 | 92 |

As shown in TABLES 7 and 8, it is seen that each of the magnetic tapes comprising the soft magnetic layer containing the spherical or ellipsoidal Fe—Co-containing soft magnetic particles having a saturation magnetization of from 170 to 220 Am²/kg as the lower layer, could have the ferromagnetic layer superior in squareness in the vertical direction and surface smoothness, and was also superior in reproduction output and resolution during recording with short wavelengths. It is also seen that the magnetic tapes having the ferromagnetic layer high in squareness in the vertical direction were further improved in reproduction output.

In contrast, it is seen that the reproduction outputs and the resolutions of the magnetic tapes comprising the soft magnetic layer containing the Fe—Co-containing soft magnetic particles having low saturation magnetization as the lower layer were substantially in the same levels as those of the magnetic tape comprising the soft magnetic layer containing the Mn—Zn ferrite soft magnetic particles as the lower layer. In addition, the magnetic recording medium comprising the thick ferromagnetic layer tends to degrade in output and resolution during recording with short wavelengths.

1. A magnetic recording medium comprising a nonmagnetic substrate, and a soft magnetic layer and a ferromagnetic layer formed in this order on the nonmagnetic layer, wherein
the ferromagnetic layer has a thickness of from 3 to 150 nm, contains spherical, ellipsoidal or plate-form ferromagnetic particles and a binder, and has an axis of easy magnetization substantially in the vertical direction, and
the soft magnetic layer contains spherical or ellipsoidal Fe—Co-containing soft magnetic particles having a saturation magnetization of from 170 to 220 Am²/kg, and a binder.

2. The magnetic recording medium of claim 1, wherein said soft magnetic layer has a magnetic permeability of at least 10.

3. The magnetic recording medium of claim 1, wherein said Fe—Co-containing soft magnetic particles contain aluminum.

4. The magnetic recording medium of claim 3, wherein a content of aluminum in said Fe—Co-containing soft magnetic particles is from 2 to 35 atomic % based on the total number of iron and cobalt atoms.

5. The magnetic recording medium of claim 1, wherein said Fe—Co-containing soft magnetic particles have a particle size of from 2 to 30 nm and an axial ratio of from 1 to 2.

6. The magnetic recording medium of claim 1, wherein said Fe—Co-containing soft magnetic particles have a coercive force of from 2 to 10 kA/m.

7. The magnetic recording medium of claim 1, wherein said soft magnetic layer contains 65 to 90% of said Fe—Co-containing soft magnetic particles.

8. The magnetic recording medium of claim 1, wherein said ferromagnetic layer has a squareness of from 0.70 to 0.98 in a vertical direction obtained by measurement of a vertical Kerr rotation angle.

9. The magnetic recording medium of claim 1, wherein said ferromagnetic particles contained in said ferromagnetic layer are at least one kind of ferromagnetic particles selected from the group consisting of iron nitride-based magnetic particles, Co-based magnetic particles as said ferromagnetic particles and barium ferrite magnetic particles.

10. The magnetic recording medium of any one of claims 1 to 9, wherein said ferromagnetic particles have a particle size of from 5 to 50 nm and an axial ratio of from 1 to 2.

11. The magnetic recording medium of claim 1, wherein said ferromagnetic layer contains 40 to 90% of said ferromagnetic particles.

12. The magnetic recording medium of claim 11, wherein a nonmagnetic layer containing nonmagnetic particles and a binder is further provided between said nonmagnetic substrate and said soft magnetic layer.
